(19) United States
(12) Patent Application Publication
(10) Pub. No.: US 2013/0339768 A1
(43) Pub. Date: Dec. 19, 2013

(54) IP POWER CONTROLLER

(71) Applicants: Chiu-Ming LEE, New Taipei City (TW); Wei-Chieh HO, New Taipei City (TW)

(72) Inventors: Chiu-Ming LEE, New Taipei City (TW); Wei-Chieh HO, New Taipei City (TW)

(21) Appl. No.: 13/495,301

(22) Filed: Jun. 13, 2012

(51) Int. Cl. G06F 1/26

(52) U.S. Cl. 713/310

(57) ABSTRACT

An IP power controller for linking with multiple computers to a central control system is disclosed to include a control system consisting of a MCU, an input unit, a time calculator, a memory, a signal transmission interface, a power manager and an AC/DC converter, and a power supply system consisting of a power control, a power receiving interface and a plurality of power supply interfaces. When the computers are powered off, the MCU of the control system controls the power control of the power supply system to shut off power supply, stopping transmission of power supply from the power receiving interface to the power supply interfaces, and therefore the power supply interfaces are off after the computers are turned off.

### BACKGROUND OF THE INVENTION

1. Field of the Invention

The present invention relates to computer remote power control technology and more particularly, to an IP power controller comprised of a control system linked to a central control system and a power supply system linked to computers for enabling the central control system to cut off power supply from the computers subject to a predetermined setting.

2. Description of the Related Art

With the rapid progress of technology and fast development of electronic and information industries, various advanced electrical and electronic products can be seen in our living environment. In our daily life, works and recreational activities, many different electrical and electronic products, such as computer and computer-related products may be used. Development and application of Internet turns our busy life to a boundless delight. Many things can be done rapidly and efficiently through a computer. Due to the advantages of convenience, quickness and accuracy of computer and information technology, people rely more and more on the web to fulfill their information needs. In the working environment of a large-scale company, several tens or hundreds of computers may be used. It is a complicated task to manage such a large number of computers. After the work, all the computers must be turned off. It takes much time and labor to check the power shut-off status of a large number of computers individually and daily. In actual application, this individual computer power shut-off checking method has drawbacks as follows:
1. In regular computer operating environments, it needs to check the power shut-off status of every individual computer after the end of the duty day, complicating the management.
2. The computers in most companies are linked to the Internet, and may be intruded by a data theft if they are not powered off.
3. If a computer is not powered off after the work, the computer and the related peripheral apparatuses will keep consuming power supply and releasing waste heat and tend to damage due to overheat.
4. When the power cable of a computer keeps conducted to city power supply after the work, the computer keeps consuming standby power supply, shortening the working life.
5. In many computer application environments, such as: office, library or educational place, the computer using time is not completely controllable, and the computers may be used overtime, bringing trouble to management.

Therefore, it is desirable to provide a measure for controlling power shut-off of a large number of computers automatically, preventing the computers from an intrusion to steal data, saving such computer management time and labor, and achieving a high level of safety.

### SUMMARY OF THE INVENTION

The present invention has been accomplished under the circumstances in view. It is therefore the main object of the present invention to provide an IP power controller, which controls power shut-off of a large number of computers automatically subject to a predetermined setting, preventing the computers from an intrusion to steal data, saving such computer management time and labor, and achieving a high level of safety.

To achieve this and other objects of the present invention, an IP power controller is electrically connected to a central control system and a plurality of computers for enabling the central control system to control power-off of the computers. The IP power controller comprises a control system and a power supply system. The control system comprises a MCU (Main Control Unit), an input unit electrically connected to the MCU (Main Control Unit) for data input, a time calculator electrically connected to the MCU (Main Control Unit), a memory electrically connected to the MCU (Main Control Unit) for storing data, a signal transmission interface electrically connecting the MCU (Main Control Unit) to one communication interface of the central control system, a power manager electrically connected to the MCU (Main Control Unit), and an AC/DC converter electrically connected to the power manager for converting AC power supply to a predetermined DC power supply. The power supply system comprises a power control electrically connected to the AC/DC converter, a power receiving interface electrically connected to the power control, and a plurality of power supply interfaces respectively electrically connecting the power transmission interfaces of the computers to the power control. When the computers are powered off, the MCU (Main Control Unit) of the control system controls the power control of the power supply system to shut off power supply, stopping transmission of power supply from the power receiving interface to the power supply interfaces, and therefore the power supply interfaces are off after the computers are powered off.

Subject to the arrangement of linking the IP power controller to multiple computers and then linking the IP power controller and the computers to the central control system, the central control system can cut off power supply from the computers after the computers have been shut off, preventing consuming standby power supply.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a circuit block diagram of the present invention.

FIG. 2 is a block diagram illustrating an application example of the IP power controller in accordance with the present invention.

### DETAILED DESCRIPTION OF THE PREFERRED EMBODIMENT

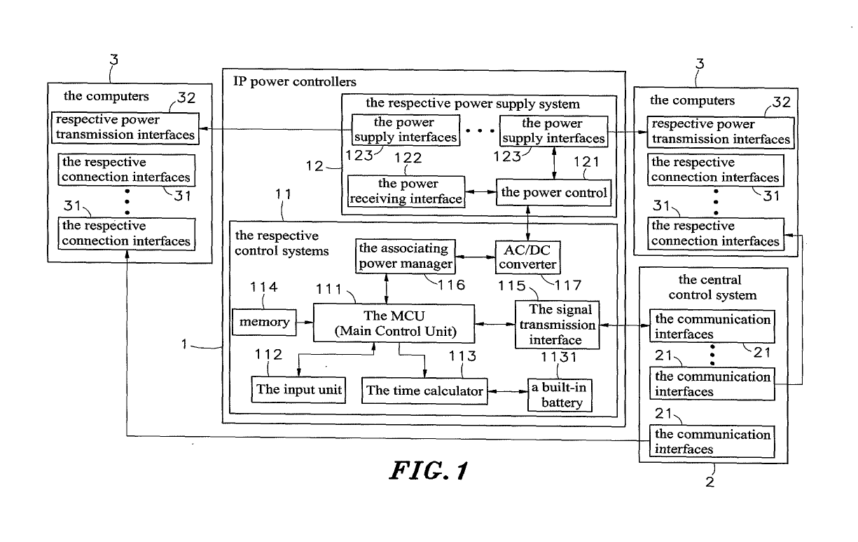

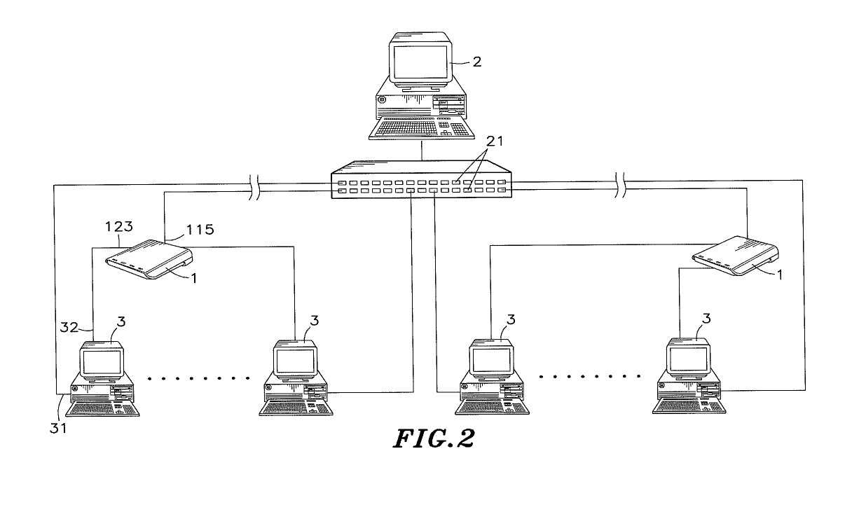

Referring to FIGS. 1 and 2, an IP power controller in accordance with the present invention is shown. The IP power controller 1 comprises a control system 11, and a power supply system 12.

The control system 11 of the IP power controller 1 comprises a MCU (Main Control Unit) 111 used to bridge power connects, an input unit 112, a time calculator 113, a memory 114, a signal transmission interface 115, a power manager 116, and an AC/DC converter 117. The input unit 112, the time calculator 113, the memory 114, the signal transmission interface 115 and the power manager 116 are respectively electrically coupled with the MCU (Main Control Unit) 111. The AC/DC converter 117 is electrically coupled to the power manager 116.

The power supply system 12 comprises a power control 121, a power receiving interface 122, and a plurality of power supply interfaces 123. The power receiving interface 122 and the power supply interfaces 123 are respectively electrically coupled with the power control 121.

The control system 11 of the IP power controller 1 is electrically coupled to the power control 121 of the power supply system 12 through the AC/DC converter 117, and electrically to an external power source (city power outlet, power generator or battery) by means of the power receiving interface 122 of the power supply system 12. Multiple computers 3 are respectively electrically connected to the power supply interfaces 123 of the power supply system 12. Further, the signal transmission interface 115 of the control system 11 of the IP power controller 1 and a connection interface 31 of each of the computers 3 are respectively electrically coupled to respective communication interfaces 21 of a central control system 2. Thus, by means of controlling the power shut-off time of the computers 3 (for example, to turn off the computer after 5 or 10 minutes), the central control system 2 can set a break-time for the IP power controller 1 (for example, to shut off power supply after a time delay of 10 or 15 minutes), and remind the computers 3 of the power-off operation prior to power shut-off. When the computers 3 are turned off subject to setting, the MCU (Main Control Unit) 111 of the control system 11 of the IP power controller 1 controls the power control 121 of the power supply system 12 to cut off power supply, stopping transmission of power supply from the power receiving interface 122 to the power supply interfaces 123, and therefore the power supply interfaces 123 are off after the computers 3 are powered off, achieving power-off control of the IP power controller 1.

The MCU (Main Control Unit) 111 of the control system 11 of the IP power controller 1 can be a chip or monolithic IC. The input unit 112 of the control system 11 of the IP power controller 1 can be a keyboard, mouse, remote controller, press switch or change-over switch operable to control the operation of the IP power controller 1 or to input data into the IP power controller 1. The time calculator 113 has a built-in battery 1131 that can be a dry cell battery, lithium-ion battery or rechargeable battery. The signal transmission interface 115 can be a RJ-45 connector, optical fiber connector or coaxial cable connector. The power receiving interface 122 of the power supply system 12 can be an electrical plug or electrical socket electrically connectable to city power supply. The power supply interfaces 123 can be power sockets or extension power strips.

Further, the central control system 2 can be electrically coupled to multiple IP power controllers 1 and multiple computers 3 by transmission cables, or by wireless transmission technology (RF, ZigBee, BT or Wi-Fi transmission technology), achieving remote power control.

Further, the power supply interfaces 123 of the power supply systems 12 of multiple IP power controllers 1 respectively electrically connected to respective power transmission interfaces 32 of the respective computers 3, and the connection interfaces 31 of the computers 3 are respectively electrically connected to the communication interfaces 21 of the central control system 2. Further, the central control system 2 can be a central control computer system or server. Thus, the multiple computers 3 and the multiple IP power controllers 1 are controllable by the remote central control system 2, i.e., the multiple computers 3 and the multiple IP power controllers 1 are centrally controlled through the remote central control system 2 without needing to check the multiple computers 3 individually, preventing the computers from an intrusion to steal data, saving much computer management time and labor, and achieving a high level of safety. Further, the central control system 2 and the multiple computers 3 have built therein an operating system (for example, Microsoft Windows Operating System) for various operation controls and word processing. After the multiple IP power controllers 1, the remote central control system 2 and the multiple computers 3 are linked, the power receiving interfaces 122 of the power supply systems 12 of the multiple IP power controllers 1 are electrically connectable to an external power source (city power supply or power generator), enabling inputted power supply to be transmitted through the respective power supply interfaces 123 to the respective computers 3. Further, the electric energy obtained from the external power source through the associating power receiving interfaces 122 for the operation of the IP power controllers 1 can be transmitted through the power controls 121 of the respective power supply system 12 to the AC/DC converters 117 of the respective control systems 11 for converting to the necessary DC voltage and amperage.

Further, when operating the central control system 2 to control the multiple computers 3 and the multiple IP power controllers 1, the computers 3 are controlled by the central control system 2 through the communication interfaces 21 and the respective connection interfaces 31 to set power shut-off time (for example, 5 minutes, 8 minutes, or any other length of time), and then the IP power controllers 1 are controlled by the central control system 2 through the communication interfaces 21 and the respective signal transmission interface 115 to set break-time (for example, 10 minutes or 15 minutes). The break-time setting signal is transmitted through the MCU (Main Control Unit) 111 of the control system 11 of each IP power controller 1 to the associating time calculator 113 and memory 114. Before the set power shut-off time is up, the IP power controllers 1 issue the power shut-off message to the respective computers 3, reminding the computers 3 to prepare the power shut-off work. When the set break-time is up, the time calculator 113 provides a signal to the MCU (Main Control Unit) 111 of the control system 11 of the respective IP power controller 1, enabling the MCU (Main Control Unit) 111 to control the power control 121 of the respective power supply system 12 through the associating power manager 116 and AC/DC converter 117, thereby stopping the power receiving interface 122 of the respective power supply system 12 from transmitting power supply to the respective power supply interfaces 123. At this time, the power supply interfaces 123 provide no power supply to the respective computers 3. Thus, when the computers 3 are shut down, the respective power supply interfaces 123 are off, avoiding wasting power supply. Further, peripheral apparatuses of the computers 3 (such as: screens, scanners, printers, mobile data storage devices and/or external storage devices) can also be linked to the multiple IP power controllers 1. Thus, when the IP power controllers 1 are powered off, the respective peripheral apparatus are also powered off, avoiding consuming standby power and generation of heat due to the consumption of standby power. In consequence, the computers and the related peripheral apparatuses can be cooled down after power-off and the working life of the computers and the related peripheral apparatuses can be greatly prolonged.

It is to be understood that the aforesaid embodiment is simply an example for the understanding of the spirit and scope of the invention but not to be served as limitations. According to the present invention, the MCU (Main Control Unit) 111 of the control system 11 of the IP power controller 1 controls the power control 121 of the power supply system 12. When the control system 11 of the IP power controller 1 receives a break-time signal from the remote central control system 2 through the signal transmission interface 115, the signal is transmitted to the time calculator 113 and the memory 114. When the remote central control system 2 controls the computers 3 to shut down at a predetermined time in a proper order, the IP power controller 1 reminds the computers 3 a predetermined length of time prior to the set power shut-off time. When the set break-time is up, the time calculator 113 enables the MCU (Main Control Unit) 111 to control the power control 121 of the power supply system 12 through the power manager 116 and the AC/DC converter 117. Thus, when the computers 3 are powered off subject to setting, the MCU (Main Control Unit) 111 of the control system 11 of the IP power controller 1 controls the power control 121 of the power supply system 12 to shut off power supply, stopping transmission of power supply from the power receiving interface 122 to the power supply interfaces 123, and therefore the power supply interfaces 123 are off after the computers 3 are turned off, achieving power-off control of the IP power controller 1.

In conclusion, the invention provides an IP power controller, which has the advantages and features as follows:
1. When the computers 3 are shut off, the central control system 2 controls the IP power controller 1 to cut off power supply from the computers 3, avoiding consuming standby power supply, thereby prolonging the working life of the computers 3.
2. When the computers 3 are shut off, the IP power controller 1 is controlled to cut off power supply from the computers 3, protecting the computers 3 from an intrusion to steal data.
3. The IP power controller 1 and the computers 3 are linked to the remote central control system 2, and the central control system 2 can control the IP power controller 1 controlled to cut off power supply to the computers 3 automatically subject to a predetermined setting, saving such computer management time and labor, and achieving a high level of safety.
4. The IP power controller 1 issues a reminding message to the computers 3 prior to the power shut-down time, enabling the computer users to make preparation.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An IP power controller electrically connected to a central control system and a plurality of computers for enabling said central control system to control power-off of said computers, said central control system comprising a plurality of communication interfaces, each said computer comprising a connection interface linked to one communication interface of said central control system and a power transmission interface, the IP power controller comprising:
a control system comprising a MCU (Main Control Unit), an input unit electrically connected to said MCU (Main Control Unit) for data input, a time calculator electrically connected to said MCU (Main Control Unit), a memory electrically connected to said MCU (Main Control Unit) for storing setting parameters data, a signal transmission interface electrically connecting said MCU (Main Control Unit) to one communication interface of said central control system, a power manager electrically connected to said MCU (Main Control Unit) and an AC/DC converter electrically connected to said power manager for converting AC power supply to a predetermined DC power supply; and
a power supply system comprising a power control electrically connected to said AC/DC converter, a power receiving interface electrically connected to said power control and a plurality of power supply interfaces respectively electrically connecting the power transmission interfaces of said computers to said power control for enabling said MCU (Main Control Unit) of said control system to control said power control of said power supply system to shut off power supply wherein when said computers are powered off, stopping transmission of power supply from said power receiving interface to said power supply interfaces.

2. The IP power controller as claimed in claim 1, wherein said input unit of said control system is selected from the group of keyboard, mouse, remote controller, press switch and change-over switch.

3. The IP power controller as claimed in claim 1, wherein said signal transmission interface of said control system is selected from the group of RJ-45 connector, optical fiber connector, coaxial cable connector, RF wireless transmission technology, ZigBee, BT and Wi-Fi.

4. The IP power controller as claimed in claim 1, wherein said time calculator comprises a built-in battery selected from the group of dry cell battery, lithium-ion battery and rechargeable battery.

5. The IP power controller as claimed in claim 1, wherein said power receiving interface of said power supply system is selected from the group of electrical plug and electrical socket electrically connectable to city power supply.

6. The IP power controller as claimed in claim 1, wherein said power supply interfaces of said power supply system are selected from the group of power sockets and extension power strips.
